(19) United States
(12) Patent Application Publication
(10) Pub. No.: US 2017/0231267 A1
(43) Pub. Date: Aug. 17, 2017

(54) TOBACCO FLAVOR EXTRACT WITH REDUCED TSNAS

(71) Applicant: Huabao USA, Inc., Raleigh, NC (US)

(72) Inventors: Xuling Shi, Raleigh, NC (US); Xiaoming Yang, Chapel Hill, NC (US)

(21) Appl. No.: 15/042,820

(22) Filed: Feb. 12, 2016

(51) Int. Cl. A24B 15/26; B01D 15/16; A24B 15/16

(52) U.S. Cl. CPC A24B 15/26; A24B 15/16; B01D 15/165; B01D 11/0288

(57) ABSTRACT

A method for preparing a tobacco flavor extract from cured tobacco materials. The tobacco flavor extract has reduced level of tobacco specific nitrosamines (TSNAs) and/or nicotine. The tobacco flavor extract is suitable for use in an electronic smoking device to provide a tobacco taste for a user of the electronic smoking device. The method preserves volatile and semi-volatile flavor components that can be released during a low-temperature vaporization process occurring in the electronic smoking device.

### FIELD OF THE INVENTION

The present invention relates to methods for extracting tobacco flavor components from cured tobacco materials that preserve natural tobacco flavor and have reduced levels of tobacco specific nitrosamines (TSNAs) and/or nicotine. The tobacco flavor components extracted thereof are suitable for use in electronic smoking devices to introduce a tobacco taste.

### BACKGROUND OF THE INVENTION

Electronic smoking devices are popular cigarette substitute products in the present. Such a device mimics the feeling of smoking through a vaporization process in which a liquid solution is atomized to produce an aerosol or vapor which is inhaled by the user of the device. The liquid solution may also contain an adequate amount of nicotine to provide nicotine replacement therapy and help smoking cessation.

While electronic smoking devices have gained significant popularity in recent years, evidence suggests that many users of electronic smoking devices still use regular cigarette products frequently and that few have completely switched from smoking cigarettes to using vaporizers. Part of the reason is that there are still considerable differences between cigarette smoking and vaporizing even though electronic smoking devices may be a suitable means for nicotine replacement and may stimulate the excitement of the feeling of smoking. One such difference is that most commonly used e-liquids in electronic smoking devices do not provide a tobacco taste that accompanies cigarette smoking and is produced during tobacco combustion. One possible way to simulate the tobacco taste in electronic smoking devices is to include in the liquid solution tobacco flavor components extracted from cured tobacco materials which are used for cigarettes. Common flavoring materials for liquid solutions used in electronic devices, however, are obtained from food products and do not contain a tobacco flavor component. Thus there is a need to provide tobacco flavor components extracted from cured tobacco materials for use in electronic smoking devices. Further, there is a need to retain volatile and semi-volatile flavor components because they can be released under a low-heat vaporization condition in an electronic smoking device to provide a tobacco taste.

Cured tobacco materials contain, inter alia, a group of strong carcinogens called tobacco-specific nitrosamines (“TSNAs”) and eliminating these carcinogens are considered beneficial for reducing the risk of smoking related cancer. Thus it is also desirable to eliminate TSNAs from the tobacco flavor components used for electronic smoking devices. While methods for reducing or eliminating TSNAs from tobacco materials have been developed, those methods are not suitable for extracting tobacco flavor components for use in electronic smoking devices for one or more reasons including but not limited to: 1) the method utilizes a solvent that is harmful for human consumption but hard to eliminate after TNSA removal; 2) the method causes substantial loss of volatile or semi-volatile flavor components; 3) the method retains substantial amount of non-volatile flavor component; and 4) the method is cost prohibitive. As such, there exists a need to cost effectively eliminate TSNAs from the tobacco flavor components extracted from tobacco such that the extracts are suitable for use in electronic smoking devices.

Existing methods to reduce the level of TSNAs in tobacco products include: (1) methods for suppressing formation of TSNA; and (2) methods for removing TSNAs formed. Examples of the former include a method of decreasing the content of alkaloids in tobacco leaves by reducing the amount of nitrogenous fertilizer; a method of reducing TSNA formed during the curing process, by adopting an indirect-heating type of curing barn in place of a direct-heating type of curing barn to reduce the exposure of tobacco with nitric oxides (U.S. Pat. No. 6,895,974); a method of breeding a new tobacco varieties having less alkaloid content, which method relies on progress of the breeding technology (WO/2002/100199); and the like. Further, a method has recently been reported in which formation of TSNA is suppressed by microwave irradiation (PCT National Publication No. 2001-503247). However, such rapid drying and curing as caused by the aforementioned treatment with microwaves results in insufficient change in the type of components of the tobacco leaves, which change would be effected in a satisfactory manner in the conventional curing process. Therefore, the resulting tobacco leaves which have been cured more rapidly than by the conventional method exhibits poor taste when smoked. In general, because the tobacco flavor that caters to the taste of smokers is obtained through traditional curing process, methods that suppress TSNA formation from tobacco curing do not lead to desirable tobacco flavor components.

A handful of methods have been reported for removing TSNAs formed in tobacco products. U.S. Pat. No. 5,810,020 discloses a method to remove nitrosamines by a liquid-liquid extraction treatment using a great amount of crown ether. Such a method retains a significant portion of non-volatile components which, as discussed, are not suitable for use in e-liquids. Further, liquid-liquid extraction treatment using crown ether often leads to substantial flavor loss. Additionally, in order for the extracted tobacco flavor components to be used in e-liquids which are inhaled by human, any potential harmful extraction agent must be adequately removed. Eliminating extraction agent such as crown ether disclosed in the '020 patent can be challenging and costly. EP2117363 discloses a method to remove TSNAs from liquid tobacco extract using a TSNA selective absorption agent having a TSNA selectivity index of at least 2. Such a method also retains a significant portion of non-volatile components and leads to substantial flavor loss. Further, the desired flavoring components are retained in a different extraction portion, requiring further separation. Additionally, TSNA reduction rate achieved through this method is suboptimal. Moreover, such a method also suffers from difficulties in removing extraction agent for human consumption. EP2827727 discloses a method for reducing TSNAs by treating a tobacco with supercritical carbon dioxide. While such a method does not require removal of extraction agent, the TSNA reduction rate achieved is not optimal and the method leads to substantial flavor loss. Further, the method is cost inhibitive. WO/2001/065954 discloses a method to remove TSNAs from tobacco leaves by super critical extraction. However, this method again suffers difficulties as in EP2827727 and also has not been adopted in practice due to its high cost.

Due to the above-described circumstances, there is a need for a novel method for reducing or removing TSNAs while retaining natural tobacco flavors in tobacco extracted tobacco flavor components suitable for use in electronic smoking devices. Tobacco flavor components extracted thereof maintain natural tobacco taste satisfactory to consumers of electronic smoking devices while having minimum content of TSNAs. As described herein, the present invention discloses methods for obtaining tobacco flavor extracts that have these desired properties. Further, the present invention retains most of the tobacco flavor components, does not introduce artificial flavors, and is of low-cost and suitable for practical use.

Nicotine may be included in the liquid solutions used in electronic smoking devices, for example, for the purpose of providing nicotine replacement therapy. Typically, the amount of nicotine to be added to the liquid solution is specifically calibrated. Eliminating nicotine from the tobacco flavor components extracted from cured tobacco materials can help better calibrate the amount of nicotine included in the liquid solution and prevent excess nicotine. Therefore, there is a need to eliminate nicotine from the extracted tobacco flavor components for use in electronic smoking devices. The present invention also discloses methods to adequately remove nicotine from the tobacco flavor extracts.

### BRIEF DESCRIPTIONS OF THE DRAWINGS

FIG. 1 includes an illustration of a flow diagram of a method for preparing a tobacco flavor extract from cured tobacco materials in accordance with one embodiment of the present invention.

FIG. 2 includes an illustration of a flow diagram of a method to remove TSNAs and/or nicotine for purification of the tobacco flavor extract in accordance with one embodiment of the present invention.

### DETAILED DESCRIPTION OF THE INVENTION

Generally, the present invention provides a method for extracting tobacco flavor components from cured tobacco materials that are suitable for use in electronic smoking devices. The method retains volatile and semi-volatile flavor components that can be released during vaporization to provide a tobacco taste and enhance user experience of electronic smoking devices. The extraction is performed under room temperature to optimally retain desired flavor components.

Further, the method adequately removes tobacco-specific nitrosamines (“TSNAs”) and nicotine from the extracted tobacco flavor components.

An electronic smoking device refers to a type of battery-powered vaporizer which simulates the feeling of smoking but does not combust or burn tobacco. Such a device typically contains a heating element that acts as an atomizer or nebulizer, a liquid storage chamber, and a mouthpiece. A user activates the heating element, which atomizes the liquid solution stored in the storage chamber and produces an aerosol or vapor. The vapor then flows into the mouth of the user, mimicking the experiences of smoking. Electronic smoking devices are designed with an objective to help quit smoking by providing a stimulated feeling of smoking and additionally eliminate many harmful substances produced by combustion of tobacco. The liquid used in an electronic smoking device, commonly known as the e-liquid or e-juice, may include nicotine and thus can provide an adequate amount of nicotine for a user of the device like other nicotine replacement therapies that help smoking cessation.

Marketed electronic smoking devices have a wide variety of shapes and designs. For example, cigalikes are designed to look like a regular cigarette and may either be disposable or include replaceable cartridges for storing e-liquids. Another common type is eGo, which is larger than cigalikes with refillable liquid tanks. Additionally, some seasoned electronic smoking device users may prefer mods, which are made by alternating existing parts and can be adapted for do-it-yourself (“DIY”) type of customizations.

Cigarette smoking combusts or burns tobacco at a temperature ranging from around 500° C. to around 900° C. On the other hand, the use of an electronic smoking device involves producing an aerosol or vapor with low heat at a much lower temperature, typically from around 100° C. to around 300° C. Such a process is commonly referred to as “vaping” and the devices are also called vapers. The aerosol or vapor is produced from an e-liquid. E-liquids can be made of any suitable liquid solutions. For example, one type of e-liquids may comprise propylene glycol, glycerin and more commonly vegetable glycerin, water, nicotine, and flavorings. Other types of e-liquids may be without propylene glycol, without nicotine, or without flavors. E-liquid can be stored in cartridges, tanks, or other suitable means and included for use in electronic smoking devices.

From a user's perspective, one significant difference between smoking and vaping is that most commonly used e-liquids in electronic smoking devices do not provide a tobacco taste that accompanies cigarette smoking and is produced during tobacco combustion. Such a tobacco taste is primarily derived in the course of tobacco combustion during which a mixture of different alkaloids and other chemicals are produced and/or released. As used in this patent, tobacco taste refers to a user's sensational feelings when consuming tobacco products and is derived from compositions that provoke gustatory and olfactory senses. Of the gustatory and olfactory senses, the latter is thought to play a more important role in providing the tobacco taste. The tobacco taste, for example, as obtained from cigarette smoking, is derived from tobacco flavor components that are present in the tobacco materials consumed and/or produced through tobacco combustion process. The exact compositions that create the tobacco taste have not been fully characterized but are thought to include three major categories: 1) volatile and semi-volatile flavor components that are released from the tobacco materials when consumed; 2) flavor components that are produced through Maillard reactions that accompany heating of the tobacco materials; and 3) flavor components that are produced through pyrolysis of the tobacco materials during combustion. The present invention discloses methods to obtain flavor components contributing to the first category and to a certain extent the second category of taste compositions. Follow on work will further characterize and isolate flavor components contributing to the third category of taste compositions.

Commonly used flavoring materials for e-liquids may comprise those extracted from food products, which, while enhance the taste of the vapor produced by the electronic smoking devices, fail to provide a genuine tobacco taste like one resulted from cigarette smoking. Including tobacco flavor components that are extracted from cured tobacco materials and that provide a more natural, genuine tobacco flavor in e-liquids can better cater to the smoking feeling of users of electronic smoking devices. In preparing tobacco flavor components, it is important to note that the process of vaporization utilized in electronic smoking devices occurs at a much lower temperature than tobacco combustion in cigarette smoking. The former generally occurs at from about 100° C. to about 300° C. while the latter generally occurs at from about 500° C. to about 900° C. In certain circumstances, tobacco combustion can reach a temperature of 950° C. or higher at the peak of the combustion cone. Combustion at such a high temperature can lead to production and/or release of many different flavoring components through a complicated physical and chemical process. In contrast, vaporization occurs at a much lower temperature. Because of the lower temperature utilized, it is important to release the tobacco flavor components from e-liquids during low-heat vaporization in order to better stimulate the feeling of smoking. Volatile and semi-volatile tobacco flavor components extracted from tobacco are thus important to enhance the flavor of e-liquids and mimic the taste of cigarette smoking.

As used in this patent, a “tobacco extract” refers to tobacco components obtained from cured tobacco materials using one or more suitable solvents and separated from components that are insoluble in the solvent(s) such as fibers. A tobacco extract may be dissolved in a solvent to form a liquid solution or be concentrated in a liquid or a gel like form free of solvent. A tobacco extract includes, for example but without limitation, tobacco flavor compounds, TSNA, nicotine, etc., that are present in cured tobacco materials. Cured tobacco materials include flavor components that provide a tobacco taste when the tobacco materials are consumed in a traditional way, for example, in the form of cigarette or cigar smoking, snuffing, etc. Curing can be one or more of any suitable methods depending on the initial tobacco materials, for example, air curing is commonly used for burley tobacco and sun curing is commonly used for oriental tobacco. Tobacco extract can be extracted from the cured tobacco materials such as tobacco leaves or stalks and dissolved in an organic extraction solvent. Preferably, tobacco leaves are removed from stalks and used for preparing a tobacco extract described in the present invention.

As used in this patent, “tobacco flavor extract” is the portion in a tobacco extract that includes tobacco flavor components for providing a tobacco taste when consumed. Like a tobacco extract, a tobacco flavor extract may be dissolved in a solvent to form a liquid solution or be concentrated in a liquid or a gel like form free of solvent. Curing of tobacco materials leads to the formation of a number of tobacco flavor components which are extracted and retained in a tobacco flavor extract. Tobacco flavor extract is obtained from the tobacco extract using an extraction solvent, for example, ethanol, hexane, ethyl acetate, or mixtures thereof, and dissolved in the extraction solvent. Further, tobacco flavor extract can be partitioned from the extraction solvent, for example, through the use of an entrapment solvent wherein the extraction solvent undergoes a phase change. Examples of the entrapment solvent include ethanol, hexane, ethyl acetate, mixtures thereof, and other suitable solvents. The entrapment solvent can be used in subsequent tobacco processing such as tobacco flavoring applications.

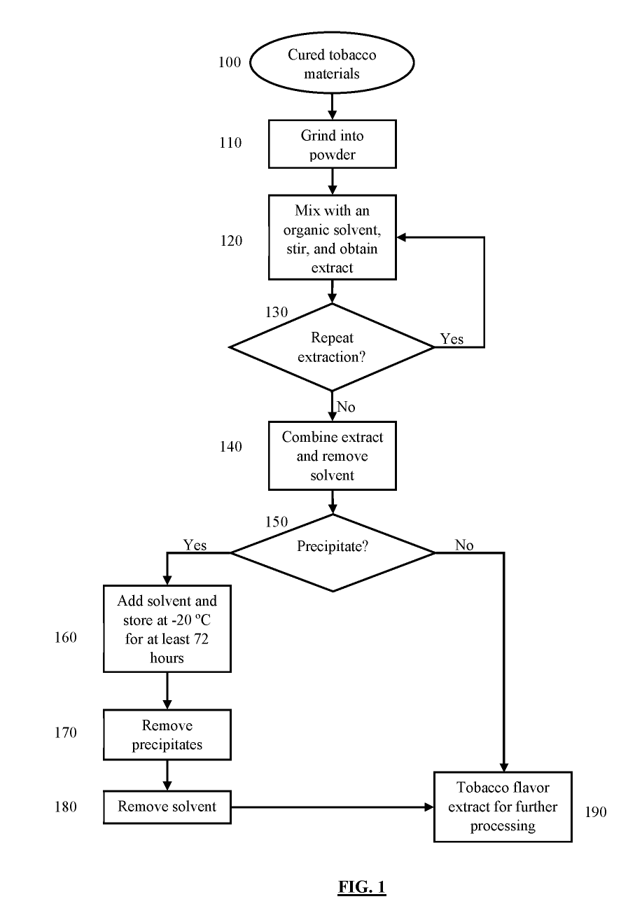

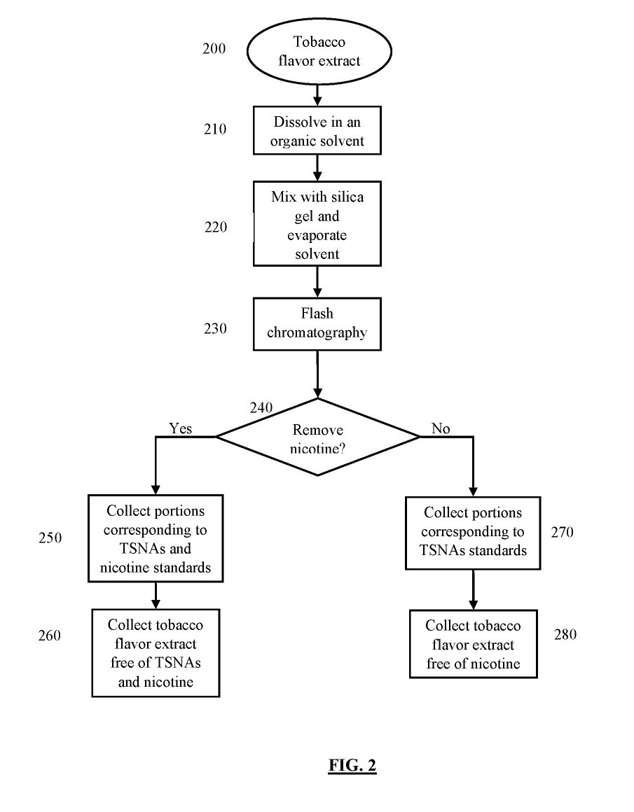

FIG. 1 describes an exemplary process for preparing a tobacco flavor extract in accordance with one embodiment of the present invention. The method begins at step 100 where cured tobacco materials are collected. Any suitable cured tobacco materials can be used for extraction. Typically, cured tobacco leaves are preferred and they are preferably dried first before the extraction process starts. At step 110, the cured tobacco materials are ground into powder. The method then proceeds to step 120 in which the tobacco powder is mixed with a suitable organic solvent, for example, ethanol, to extract tobacco flavor components. The mixture is stirred to allow for adequate mixing of the tobacco powder with the solvent such that tobacco components can be extracted and dissolved in the solvent. The soluble extract is then decanted from the solid substances which comprise mostly of fibers and a tobacco flavor extract dissolved in the solvent is collected. At step 130, a determination is made as to whether step 120 should be repeated one or more times to obtain better extraction results. For common types of cured tobacco materials, it is preferable to repeat step 120 at least once so as to better extract desired tobacco components contained in the cured tobacco materials. At step 140, the solvent of the tobacco flavor extract obtained in 120 is removed, for example, through evaporation under vacuum. If step 120 is repeated, then tobacco flavor extracts obtained each time are combined first and then the solvent removed. The tobacco flavor extract obtained at step 140 is typically a brown to dark liquid product, although the appearance may vary depending on the type of starting tobacco materials. The tobacco flavor extract can then be further processed in step 190, for example, to remove undesirable substances such as TSNAs and/or nicotine as described in FIG. 2.

Steps 100 through 140 are carried out under room temperature and generally should be controlled to be <40° C., a temperature above which Maillard reactions may occur. Preventing Maillard reactions during the extraction process is considered advantageous as such allows precursors that undergo Maillard reactions in tobacco combustion to be retained. These precursors can similarly undergo Maillard reactions during vaporization and produce products that contribute to the tobacco taste. Preferably, moisture level of the operating environment is controlled to reduce the level of water soluble components retained in the tobacco flavor extract obtained at step 140. Water soluble components may contain non-volatile flavor components that may precipitate over time and/or react with other flavor components during vaporization. However, strict control of moisture level is generally unnecessary as water soluble components can be adequately removed in subsequent steps.

At step 150, a determination is made as to whether water soluble components retained in the tobacco flavor extract obtained at step 140 should be further removed. If so, the method proceeds to step 160 and the tobacco flavor extract is dissolved in an organic solvent and kept at a low temperature for a period of time to allow the water soluble components to aggregate and form precipitates. For better precipitation results, the temperature is preferably kept at around −20° C. and the precipitation time is set to be 72 hours or longer. One of ordinary skill in the art would appreciate that variations of precipitation temperature and duration may be adopted to obtain optimal results for different tobacco materials and solvents used.

At step 170, the precipitates resulted from step 160 are removed using a suitable method, for example, by filtration or centrifugation. At step 180, the solvent contained in the solution obtained from step 170 is removed, for example, by evaporation under vacuum, to afford a refined tobacco flavor extract. As steps 100 through 140, steps 170 and 180 are carried out under room temperature and preferably controlled at <40° C. The refined tobacco flavor extract obtained after removing water soluble components is often referred to as the absolute oil. Absolute oil typically exhibits a brownish color and some degree of viscosity, although the color and viscosity may vary depending on the type of starting tobacco materials. The absolute oil can then be further processed in step 190, for example, to remove undesirable substances such as TSNAs and/or nicotine as described in FIG. 2.

In some embodiments, tobacco flavor extract is obtained using a suitable solvent which can dissolve tobacco flavor compounds. For example, hexane or ethanol can be used as an extraction solvent. Other suitable extraction solvents that may be used in lieu of or in addition to ethanol include n-propane, n-butane, n-pentane, n-hexane, n-heptane, n-cyclohexane, ethanol, n-pentanol, n-hexanol, and acetone. Mixtures of solvents can be used as needed.

Tobacco flavor extract obtained in steps 140 or 180 is preferably further processed to remove undesirable substances, for example, TSNAs and/or nicotine. Of the harmful substances present in cigarette, TSNAs are thought to be the most important ones. TSNAs are strong carcinogens and are formed from nicotine and related compounds by a nitrosation reaction during curing and processing of tobacco. TSNAs are also formed during aging of tobacco materials. During cigarette smoking, TSNAs may also be formed through the combustion process. Eliminating these carcinogens can help reduce the risk of smoking related cancer. The main TSNAs in tobacco are N′-nitrosonornicotine (which will be referred to as “NNN” hereinafter), 4-(N-nitrosomethylamino)-1-(3-pyridyl)-1-butanone (which will be referred to as “NNK” hereinafter), N′-nitrosoanatabine (which will be referred to as “NAT” hereinafter), N′-nitrosoanabasine (which will be referred to as “NAB” hereinafter), and the like. The amount of TNSAs varies depending on tobacco type and curing method. For example, on the low end, the average amount of TNSAs is about 0.7 μg/g for flue cured Virginia tobacco and on the high end, the average is about 13 μg/g for air cured burley tobacco (Risner et. al., 2000). Before it is used in the e-liquid for electronic smoking devices, a tobacco flavor extract obtained from cured materials as described in steps 140 or 180 should be further treated as it contains a substantial amount of TSNAs that are harmful for human consumption.

While methods for reducing or eliminating TSNAs from tobacco materials have been developed, those methods are not suitable for extracting tobacco flavor components for use in electronic smoking devices for one or more of reasons including: 1) the method utilizes a solvent that is harmful for human consumption but hard to eliminate after TNSA removal; 2) the method causes substantial loss of volatile or semi-volatile flavor components; 3) the method retains substantial amount of non-volatile flavor component; and 4) the method is cost prohibitive. The present invention discloses methods to cost effectively eliminate TSNAs from the tobacco flavor components extracted from tobacco such that the extracts are suitable for use in electronic smoking devices.

Nicotine may be included in e-liquid products for providing nicotine replacement therapy. Typically, the amount of nicotine to be added to e-liquids is specifically calibrated. During the extraction of tobacco flavor components from tobacco materials, nicotine may be retained in the final tobacco flavor product. Subsequently, when added to e-liquids, the extracted tobacco flavor product or further refined products thereof may lead to excess of nicotine in the liquids. Therefore, the present invention also provides methods to eliminate nicotine from the tobacco flavor components extracted from cured tobacco materials.

FIG. 2 describes an exemplary process for removing TSNAs and/or nicotine from the tobacco flavor extract in accordance with one embodiment of the present invention. Starting at step 200, a tobacco flavor extract to which TSNAs and/or nicotine are to be removed is prepared, for example, in accordance with steps 140 and 180 of the method described in FIG. 1. The refined tobacco flavor extract or absolute oil as obtained at step 180 is preferred as it contains less water soluble, non-volatile components and can increase the capacity of the column used in subsequent chromatography purification steps. At step 210, the tobacco flavor extract is mixed with an organic solvent and dissolved in the solvent. Any suitable organic solvent can be used at step 210, for example, ethanol, hexane, n-propane, n-butane, n-pentane, n-hexane, n-heptane, n-cyclohexane, n-pentanol, n-hexanol, and acetone, or a mixture thereof. At this step, it may be economically advantageous to collect and reuse the extraction solvent used in preparing the tobacco extract as the extraction solvent is evaporated. At step 220, the solution is mixed with silica gel and the solvent is evaporated under vacuum until a free flowing mixture of powder is obtained. At step 230, the mixture obtained in step 220 is purified using flash chromatography. At step 240, a determination is made as to whether only TSNAs or both TSNAs and nicotine are to be removed. If nicotine needs to be removed, elute portions corresponding to TSNAs and nicotine standards are collected from chromatography at step 250. At step 260, fractions that do not contain TSNAs and nicotine collected in step 250 are combined and solvent is removed, for example, by evaporation under vacuum. A tobacco flavor extract with reduced levels of TSNAs and nicotine is obtained and can be further processed for use in electronic smoking devices. If only TNSAs are to be removed, elute portions corresponding to TSNAs standards are collected from chromatograph at step 270. At step 280, fractions that do not contain TSNAs collected in step 270 are combined and solvent is removed in a similar fashion, resulting in a tobacco flavor extract with reduced levels of TSNAs.

As in preparing the tobacco extract from cured tobacco materials, the purification process such as flash chromatography is preferably performed under room temperature and controlled to be <40° C. As one of ordinary skill in the art would readily appreciate, settings and parameters of the process can be modified to afford optimal purification of the tobacco flavor extract to remove TSNAs and/or nicotine. For example, the portions containing TSNAs and/or nicotine corresponding to their respective standards may be collected with a margin to ensure adequate removal of TSNAs and/or nicotine.

One exemplary embodiment of the invention provides a tobacco flavor extract composition comprising tobacco extract obtained from cured tobacco materials wherein the TSNA content is at least 80% lower than the TSNA content in the cured tobacco materials and the nicotine content is at least 80% lower than the nicotine content in the cured tobacco materials. The tobacco flavor extract can be used in an electronic smoking device in any suitable fashion, for example, it can be further diluted and mixed in an adequate proportion with other flavoring components and solutions to provide an e-liquid. The tobacco flavor extract so used provides a tobacco taste for a user of the electronic smoking device. Another exemplary embodiment of the invention provides a tobacco flavor extract wherein the TSNA content is at least 90% lower than the TSNA content in the cured tobacco materials and the nicotine content is at least 90% lower than the nicotine content in the cured tobacco materials. A further example embodiment of the invention provides a tobacco flavor extract wherein the TSNA content is at least 95% lower than the TSNA content in the cured tobacco materials and the nicotine content is at least 95% lower than the nicotine content in the cured tobacco material. A further exemplary embodiment of the invention provides a tobacco flavor extract wherein the TSNA content is at least 98% lower than the TSNA content in the cured tobacco materials and the nicotine content is at least 98% lower than the nicotine content in the cured tobacco material. Yet a further exemplary embodiment of the invention provides a tobacco flavor extract wherein the TSNA content is at least 99% lower than the TSNA content in the cured tobacco materials and the nicotine content is at least 99% lower than the nicotine content in the cured tobacco materials. Exemplary embodiments can be obtained by increasing the margin with respect to the TSNAs and nicotine standards and removing portions contained within the margin during the flash chromatography process such that TSNAs and nicotine are adequately removed from the tobacco flavor extract.

The tobacco flavor extract provides a tobacco taste at a range of temperatures. Preferably, the tobacco flavor extract provides a tobacco taste at a low temperature. For example, one exemplary embodiment of the tobacco flavor extract releases a tobacco aroma at a temperature from around 100° C. to around 300° C. and contributes to a complicated feeling in the mouth, tongue, and the upper respiratory system of a user of an electronic smoking device that mimics cigarette smoking.

There is no limitation of the source of the cured tobacco materials for preparing the tobacco flavor extract. Examples of tobacco source include burley tobacco, Virginia tobacco, etc. Further, the tobacco source can be cured in any suitable fashion to obtain the cured tobacco materials. Examples of the cured tobacco materials include flue cured tobacco, dark air tobacco, oriental tobacco, light air tobacco, light fire tobacco, and aromatic fire cured tobacco, etc.

In one embodiment of the invention, a method of preparing a tobacco flavor extract with reduced level of TSNAs comprises the steps of first grinding the tobacco materials into powder and then mixing the powder with a first organic solvent and stirring the mixture at room temperature. The soluble extract is then decanted for subsequent concentration. The remaining insoluble tobacco materials are then mixed with the first organic solvent to repeat the extraction for one or more times and the soluble extracts obtained therefrom are collected and combined. The solvent in the combined soluble extracts is then evaporated under vacuum. The solvent-free tobacco extracts obtained therefrom are then dissolved in a second organic solvent and loaded onto silica gel. The solvent in the mixture is then evaporated under vacuum until a free flowing mixture of liquid is obtained. The mixture is then purified in flash chromatography using a third organic solvent.

The components at the timing of the peaks of TSNAs standard of NNN, NNK, NAT, and NAB are collected and discarded. The portions in the tobacco extracts that do not contain the TSNAs are collected to afford the tobacco flavor extract with reduced level of TSNAs. In certain embodiments, the components at the timing of the peaks of nicotine can be collected and discarded during the flash chromatography purification steps to afford a tobacco flavor extract with reduced level of TSNAs and nicotine.

There exist a number of choices of the first organic solvent, for example, ethanol, hexane, ethyl acetate, the like or a mixture thereof. Similarly, a variety of choices exist for the second organic solvent, for example, ethanol, hexane, ethyl acetate, the like or a mixture thereof. Likewise, the third organic solvent can be any suitable solvents, for example, ethanol, hexane, and the like, or a mixture thereof. In different embodiments, the same or a different solvent can be used as the first, the second, and/or the third organic solvent. The selection of the first, the second, and the third solvent should meet necessary safety standards considering their use in preparation of a product for human consumption.

In certain embodiments, the preparation method includes a further step to precipitate the tobacco flavor extract before removing TSNAs and/or nicotine. For example, the tobacco flavor extract free of solvent is stored at −20° C. for at least 72 hours to allow water soluble components to form precipitates. The precipitates formed therein are then removed using any suitable method, for example, filtration or centrifugation. The tobacco flavor extract is then dissolved in a solvent and loaded onto silica gel for further purification.

### Example

One example of the present invention for obtaining a tobacco flavor extract with reduced TSNAs and nicotine is described in detail hereunder. One of ordinary skill in the art would appreciate that experiment conditions can be adjusted as needed to accommodate for variations in starting materials, type of solvents used, levels of TSNAs and nicotine desired or allowed in the final extract, etc.

Step I: Preparation of Extracts

100 g of flue cured tobacco leaves are first ground into powders. The powders are then added to a 1 L flask and 500 ml of 200 proof ethanol are mixed with the powders. The mixture is stirred at room temperature for about 2 to 6 hours. After that, the solvent is decanted for subsequent concentration. To extract the tobacco flavor components, the above described steps starting from mixing the powders with the solvent (e.g., ethanol) are repeated at least once before combining and evaporating all solvents under vacuum and below 40° C. After removal of solvents, a brown to dark extract is obtained which is then subject to purification as described in Step II.

Step II: Preparation of Absolute Oil

50 ml 200 proof ethanol is added to the mixture which obtained in Step I and kept at −20° C. for at least 72 hours. The precipitates are filtered off and washed with 50 ml of ethanol that is precooled at −20° C. The filtrate is then concentrated under vacuum and below 40° C. until it is dried. A brown to dark oil like extract is obtained which is commonly referred to as the absolute oil. The absolute oil is subject to further purification as described in Step III.

In other embodiments, the temperature used for precipitation and the duration of precipitation can be varied to accommodate for differences in factors such as extraction solvent, moisture of operating environment, volume of extraction mixture, etc., in order to obtain optimal precipitation results. In some embodiments, Step II is optional when water soluble components are considered to be minimal in the extract obtained in Step I.

Step III: Preparation of Extracts Free of TSNAs and Nicotine

(1). TSNAs Free Tobacco Flavor Extract

10 g of tobacco absolute oil obtained from Step II, are dissolved in ethanol, and loaded onto silica gel by evaporating off the solvent under vacuum until a free flowing mixture of powders is obtained. The silica gel sample is then purified by Biotage Isolera One flash chromatography with silica gel column, for example, a 50 g KP-SIL SNAP column, using a mobile phase system of hexane/ethanol (0-100%). The optimized eluting condition is as follows: 100% hexanes for 5 mins, ethanol from 0% to 20% over 20 mins, ethanol from 20% to 100% over 3 mins, and lastly 100% of ethanol for 5 mins. Other settings of the flash chromatography are in accordance with the manufacturer specifications for the Biotage Isolera One equipment. TSNAs (including NNN, NNK, NAT, and NAB) are separated from other components of the extracts through the flash chromatography column. Fractions that do not contain the TSNAs as analyzed by WHO SOP03 are combined and solvents are removed to afford a brown to dark oil-like tobacco extract, which is used for further applications. For instance, the tobacco flavor extract so obtained can be diluted and mixed with other ingredients such as a carrier, a buffer, nicotine, and other flavoring components to provide an e-liquid for use in an electronic smoking device.

(2). TSNAs and Nicotine Free Tobacco Flavor Extract

10 g of tobacco absolute oil obtained from Step II are dissolved in ethanol and loaded onto silica gel by evaporating the solvent under vacuum until a free flowing mixture of powders is obtained.

The free-flowing silica gel sample is then purified by flash chromatography as in Step III(1), using a mobile phase system of hexane/ethanol (0-100%). %). The optimized eluting condition is as follows: 100% hexanes for 5 mins, ethanol from 0% to 20% over 40 mins, ethanol from 20% to 100% over 3 mins, and lastly 100% of ethanol for 5 mins. Other settings of the flash chromatography are in accordance with the manufacturer specifications for the Biotage Isolera One equipment. TSNAs (including NNN, NNK, NAT, and NAB) and nicotine are separated from other components of the extracts through the flash chromatography column. Fractions that do not contain the TSNAs and nicotine as analyzed by WHO SOP03 are combined and removed solvents to afford a brown to dark oil-like extract, which is used for further applications. For instance, the tobacco flavor extract so obtained can be diluted and mixed with other ingredients such as a carrier, a buffer, nicotine, and other flavoring components to provide an e-liquid for use in an electronic smoking device.

Results

More than 98% TSNAs and Nicotine are removed using flash chromatography purification method described above. The results are confirmed using analytical instruments with LC-MSMS according to the WHO official method (WHO SOP03), as shown in the chromatograms below (extract-I v. standard).

(1). Standard

What is claimed is:

1. A tobacco flavor extract composition comprising:
a) tobacco extract obtained from cured tobacco materials;
b) wherein the TSNA content is at least 80% lower than the TSNA content in the cured tobacco materials;
c) the nicotine content is at least 80% lower than the nicotine content in the cured tobacco materials; and;
d) wherein the tobacco flavor extract provides a tobacco taste when used in an electronic smoking device.

2. The tobacco flavor extract according to claim 1 wherein the TSNA content is at least 90% lower than the TSNA content in the cured tobacco materials and the nicotine content is at least 90% lower than the nicotine content in the cured tobacco materials.

3. The tobacco flavor extract according to claim 1 wherein the TSNA content is at least 95% lower than the TSNA content in the cured tobacco materials and the nicotine content is at least 95% lower than the nicotine content in the cured tobacco materials.

4. The tobacco flavor extract according to claim 1 wherein the TSNA content is at least 98% lower than the TSNA content in the cured tobacco materials and the nicotine content is at least 98% lower than the nicotine content in the cured tobacco materials.

5. The tobacco flavor extract according to claim 1 wherein the TSNA content is at least 99% lower than the TSNA content in the cured tobacco materials and the nicotine content is at least 99% lower than the nicotine content in the cured tobacco materials.

6. The tobacco flavor extract composition according to claim 1-5, wherein the composition comprises one or more volatile flavor components providing a tobacco taste.

7. The tobacco flavor extract composition according to claim 6, wherein the composition comprises one or more semi-volatile flavor components providing a tobacco taste.

8. The tobacco flavor extract composition according to claim 1 wherein the composition releases a tobacco aroma at a temperature from around 100° C. to around 300° C.

9. The tobacco flavor extract composition according to claim 8 wherein the composition releases a tobacco aroma at a temperature from around 100° C. to around 250° C.

10. The tobacco flavor extract composition according to claim 8 wherein the composition releases a tobacco aroma at a temperature from around 100° C. to around 200° C.

11. The tobacco flavor extract composition according to claim 8 wherein the composition releases a tobacco aroma at a temperature from around 100° C. to around 150° C.

12. The tobacco flavor extract composition according to claim 1 wherein the composition is extracted from cured tobacco materials comprising burley tobacco.

13. The tobacco flavor extract composition according to claim 1 wherein the composition is extracted from cured tobacco materials comprising Virginia tobacco.

14. The tobacco flavor extract composition according to claim 1 wherein the composition is extracted from one or more cured tobacco materials selected from flue cured tobacco, dark air tobacco, oriental tobacco, light air tobacco, light fire tobacco, and aromatic fire cured tobacco.

15. A method of preparing a tobacco flavor extract with reduced level of TSNAs comprising the steps of:
a) grind cured tobacco materials into powder;
b) mix the tobacco powder with a first organic solvent;
c) stir the mixture at room temperature;
d) decant the solvent for subsequent concentration;
e) repeat steps b)-d) at least once;
f) combine and evaporate all solvents under vacuum;
g) dissolve the tobacco extracts obtained from step f) in a second organic solvent;
h) load the mixture of step g) onto silica gel;
i) evaporate the solvent under vacuum until a free flowing mixture of liquid is obtained;
j) run the mixture of liquid obtained from step i) in flash chromatography using a third organic solvent;
k) collect the components at the timing of the peaks of TSNAs standard of NNN, NNK, NAT, and NAB; and
l) collect the portions in the tobacco extracts that do not contain the TSNAs of step k) to afford the tobacco flavor extract.

16. A method for preparing a tobacco flavor extract with reduced level of TSNAs according to claim 15, wherein the first organic solvent is selected from ethanol, hexane, ethyl acetate or a mixture thereof.

17. A method for preparing a tobacco flavor extract with reduced level of TSNAs according to claim 15, wherein the second organic solvent is selected from ethanol, hexane, ethyl acetate or a mixture thereof.

18. A method for preparing a tobacco flavor extract with reduced level of TSNAs according to claim 15, wherein the third organic solvent is selected from ethanol, hexane, or a mixture thereof.

19. A method for preparing a tobacco flavor extract with reduced levels of TSNAs and reduced level of nicotine according to claim 15 further comprises the steps of:
i. collect the components at the timing of the peaks of nicotine standard; and
ii. collect the portions in the tobacco extracts that do not contain nicotine of i) to afford the tobacco flavor extract.

20. A method for preparing a tobacco flavor extract according to claim 15, wherein step g) comprises placing the extraction mixture at −20° C. for at least 72 hours and removing precipitates formed therein.

21. A method for preparing a tobacco flavor extract according to claim 20, wherein filtration or centrifugation is used to remove the precipitates.
